(19) United States
(12) Patent Application Publication
(10) Pub. No.: US 2013/0320681 A1
(43) Pub. Date: Dec. 5, 2013

(54) APPARATUS, SYSTEM, AND METHOD FOR MULTI-STAGE HIGH GEAR RATIO HIGH TORQUE MAGNETIC GEAR

(71) Applicant: TECO WESTINGHOUSE, Round Rock, TX (US)

(72) Inventors: Haran Karmaker, Round Rock, TX (US); Mantak Ho, Round Rock, TX (US); George Gao, Round Rock, TX (US)

(73) Assignee: TECO Westinghouse, Round Rock, TX (US)

(21) Appl. No.: 13/827,975

(22) Filed: Mar. 14, 2013

Related U.S. Application Data
(60) Provisional application No. 61/655,400, filed on Jun. 4, 2012.

(51) Int. Cl. H02K 49/10; H02K 15/00; H02K 9/19; F03D 9/00; H02K 7/10

(52) U.S. Cl. CPC H02K 49/102; F03D 9/002; H02K 7/10; H02K 9/19; H02K 15/00
USPC 290/55; 310/103; 310/54; 29/598

(57) ABSTRACT

An apparatus, system, and method for multi-state high gear ratio magnetic gear are described. The magnetic gear may have a stationary shutter assembly with a bearing supporting bracket and a shutter supporting bracket extending perpendicularly from the bearing supporting bracket. The magnetic gear may also have an outer rotor assembly with an outer rotor magnetic assembly positioned circumferentially outside of the shutter supporting bracket. In addition, the magnetic gear may have an inner rotor assembly with an inner rotor magnetic assembly positioned circumferentially inside the shutter supporting bracket. In addition, a first bearing may couple the stationary shutter assembly to the inner rotor assembly and a second bearing may couple the inner rotor assembly and the outer rotor assembly.

### PRIORITY

This application claims priority to U.S. Provisional Patent Application 61/655,400, entitled “Apparatus, System, and Method for Multi-Stage High Gear Ratio Magnetic Gear” filed 4 Jun. 2012, the entire disclosure of which is incorporated herein without disclaimer.

### BACKGROUND OF THE INVENTION

1. Field of the Invention

This invention relates to magnetic gears and more particularly relates to an apparatus, system and method for a multi-stage high gear ratio magnetic gear.

2. Description of the Related Art

Magnetic gears use permanent magnets to transmit torque between an input and output shaft. Unlike traditional gears that have teeth in physical contact, magnetic gears have no physical contact between the portions of the gear that transmit the torque. As such, compared to conventional gears, magnetic gears may have lower noise, higher efficiency, less required maintenance, and improved reliability.

### SUMMARY OF THE INVENTION

A magnetic gear is presented. In one embodiment, the magnetic gear includes a stationary shutter assembly. The stationary shutter assembly may have a bearing supporting bracket and a shutter supporting bracket extending perpendicularly from the bearing supporting bracket. In some embodiments, an outer rotor assembly having an outer rotor magnetic assembly may be positioned circumferentially outside of the shutter supporting bracket. In addition, an inner rotor assembly having an inner rotor magnetic assembly may be positioned circumferentially inside of the shutter supporting bracket. In some embodiments, a first bearing may couple the stationary shutter assembly to the inner rotor assembly. In some embodiments, a second bearing may couple the inner rotor assembly and the outer rotor assembly.

In some embodiments, the magnetic gear may also include a lubrication inlet in a first stationary element on a first side of a magnetic gear. In addition, the lubrication inlet may be configured to allow a lubricant to enter a first bearing. In some embodiments, a first conduit may be configured to allow the lubricant to flow from the first bearing to the second bearing. In some embodiments, a second conduit may be configured to allow the lubricant to flow from the second bearing to a lubrication outlet. Furthermore, the lubrication outlet may be located on the first side of the magnetic gear. In some embodiments, flood oil may be in the conduits.

In some embodiments, the magnetic gear may include a first set of alignment holes in the stationary shutter assembly. In addition, the magnetic gear may include a second set of alignment holes in the outer rotor assembly. The first and second sets of alignment holes may be configured to allow a first plurality of assembling rods to hold the stationary shutter assembly and the outer rotor assembly in alignment.

In some embodiments, the magnetic gear may include a third set of alignment holes in the outer rotor assembly. In addition, the magnetic gear may include a fourth set of alignment holes in the inner rotor assembly. Furthermore, in some embodiments, the third and fourth sets of alignment holes may be configured to allow a second plurality of assembly rods to hold the outer rotor assembly and the inner rotor assembly in alignment.

In some embodiments, the magnetic gear may be coupled to a second magnetic gear to form a multi-stage magnetic gear system. In some embodiments, the magnetic gear may be coupled to additional magnetic gears to achieve a multi-stage magnetic gear system with any desired gear ratio. In some embodiments, the multi-stage magnetic gear system may have a gear ratio of about 100 to 1. Furthermore, the multi-stage magnetic gear system may be configured to operate at a torque of about 1.1 MNm at an input speed of 16 revolutions per minute. In some embodiments, the electric generator may be rated for multi Megawatts such as, for example, between 1 and 6 Megawatts and more particularly 1.5 or 2 Megawatts. In some embodiments, the electric generator may be rated in Kilowatts such as, for example, 150 kW.

In some embodiments, the multi-stage magnetic gear system may be coupled to a wind turbine. In some embodiments, the gear ratio may exceed 100 to 1. Furthermore, the multi-stage magnetic gear system may be coupled to an electric generator. In some embodiments, the generator may be rated for generating multi-Megawatt power with multi-Mega-Newton-meter torque transmission at low wind speeds.

In some embodiments, the magnetic gear may include a cover configured to attach to the stationary shutter assembly and substantially enclose the inner rotor assembly and outer rotor assembly. In some embodiments, the stationary shutter assembly may include feet that are configured to attach the magnetic gear assembly to a surface.

In some embodiments, the outer rotor magnetic assembly and the inner magnetic assemblies may each include permanent magnet blocks and electrical steel for providing a magnetic flux path.

A method for assembling a magnetic gear assembly is also presented. In some embodiments, the method may include attaching a first plurality of alignment rods to a stationary shutter assembly. Furthermore, in some embodiments, the stationary shutter assembly may have a bearing supporting bracket and a shutter supporting bracket extending perpendicularly from the bearing supporting bracket. In some embodiments, the method may include aligning the stationary shutter assembly with an outer rotor assembly having an outer rotor magnetic assembly positioned circumferentially outside of the shutter supporting bracket. In addition, the method may include attaching a second plurality of alignment rods to the outer rotor assembly. The method may further include aligning the outer rotor assembly with an inner rotor assembly having an inner rotor magnetic assembly positioned circumferentially inside of the shutter supporting bracket. In some embodiments, the method may include coupling the inner rotor assembly to the stationary shutter assembly with a first bearing. In some embodiments, the method may include coupling the inner rotor assembly to the outer rotor assembly with a second bearing. In addition, in some embodiments, the method may include removing the first plurality of alignment rods and the second plurality of alignment rods.

In some embodiments, the method may include the configuration where the first plurality of alignment rods is positioned circumferentially around the stationary shutter assembly. In addition, the second plurality of alignment rods may be positioned circumferentially around the inner rotor assembly.

A method for cooling a magnetic gear assembly is also presented. In some embodiments, the method may include inserting a lubricant into a lubrication inlet. For example, the lubricant may be flood oil. In some embodiments, the lubrication inlet may be in a first stationary element on a first side of a magnetic gear. In some embodiments, the method may include the step of causing the lubricant to enter a first bearing. In addition, the method may include the step of causing the lubricant to flow through a first conduit in an inner rotor assembly from the first bearing to a second bearing. The method may also cause the lubricant to flow through a second conduit in the inner rotor assembly from the second bearing to a lubrication outlet. In some embodiments, the lubrication outlet may be located on a second stationary element on the first side of the magnetic gear.

In some embodiments, the first stationary element may be the same element as the second stationary element. In some embodiments, the method may include altering the flow rate of the lubricant to control the temperature of the first and second bearings.

The term “coupled” is defined as connected, although not necessarily directly, and not necessarily mechanically.

The terms “a” and “an” are defined as one or more unless this disclosure explicitly requires otherwise.

The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially,” “approximately,” and “about” may be substituted with “within [a percentage] of” what is specified, where the percentage includes 0.1, 1, 5, and 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more elements. Likewise, a step of a method or an element of a device that “comprises,” “has,” “includes” or “contains” one or more features possesses those one or more features, but is not limited to possessing only those one or more features. Furthermore, a device or structure that is configured in a certain way is configured in at least that way, but may also be configured in ways that are not listed.

Any embodiment of any of the devices, systems, and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Other features and associated advantages will become apparent with reference to the following detailed description of specific embodiments in connection with the accompanying drawings.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein. The embodiments of the present magnetic gears, and their components shown in the figures, are drawn to scale for at least the embodiments shown.

FIG. 1 shows a stationary shutter assembly that can be used in a high gear ratio magnetic gear.

FIG. 2 shows another view of the stationary shutter assembly shown in FIG. 1.

FIG. 3 shows a stationary shutter assembly and an outer rotor assembly.

FIG. 4 shows a stationary shutter assembly, outer rotor assembly, and an inner rotor assembly.

FIG. 5 shows another view of the stationary shutter assembly, outer rotor assembly, and an inner rotor assembly shown in FIG. 4.

FIG. 6 shows a cross sectional view of a magnetic gear.

FIG. 7 shows two magnetic gears coupled together.

FIGS. 8 and 9 show the multi-stage magnetic gear system of FIG. 7.

FIG. 10 shows a block diagram of a wind turbine electricity generation system that uses a multi-stage magnetic gear system.

FIG. 11 is a flow chart diagram of a method for assembling a magnetic gear.

FIG. 12 is a flow chart diagram of a method for cooling a magnetic gear.

### DETAILED DESCRIPTION

Various features and advantageous details are explained more fully with reference to the nonlimiting embodiments that are illustrated in the accompanying drawings and detailed in the following description. Descriptions of well known starting materials, processing techniques, components, and equipment are omitted so as not to unnecessarily obscure the invention in detail. It should be understood, however, that the detailed description and the specific examples, while indicating embodiments of the invention, are given by way of illustration only, and not by way of limitation. Various substitutions, modifications, additions, and/or rearrangements within the spirit and/or scope of the underlying inventive concept will become apparent to those skilled in the art from this disclosure.

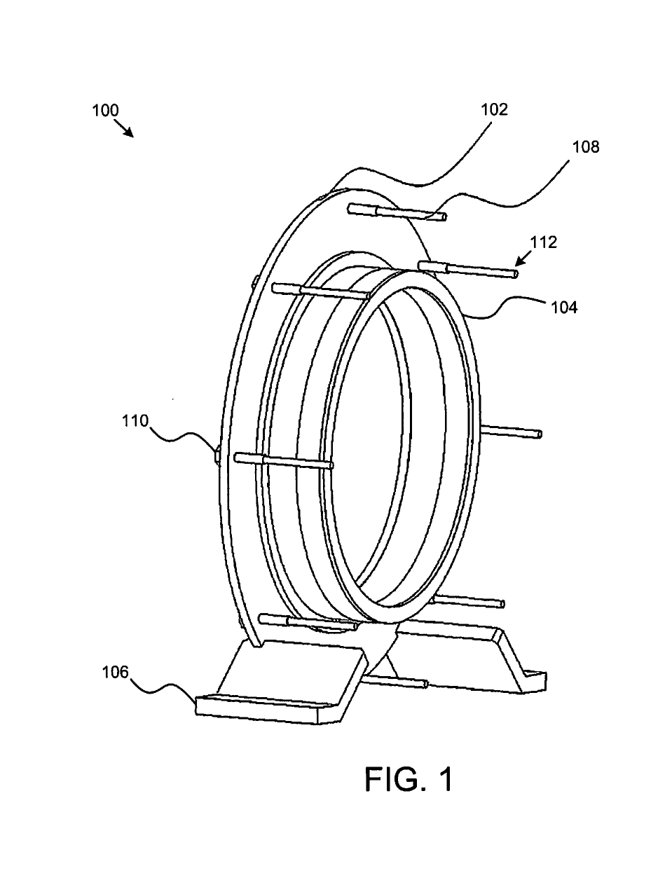

FIG. 1 illustrates one embodiment of a stationary shutter assembly 100 that can be used in a high gear ratio magnetic gear. The stationary shutter assembly has a bearing supporting bracket 102. The bearing supporting bracket 102 is made of a rigid metal, such as steel. The stationary shutter assembly 100 also has a shutter supporting bracket 104 extending perpendicularly from the bearing supporting bracket 102. In some embodiments, the shutter supporting bracket 104 may be welded to the bearing supporting bracket 102. The bearing supporting bracket 102 is held stationary by supporting feet 106. In this figure, there are two supporting feet 106 that are attached to the bearing supporting bracket 102.

The stationary shutter assembly 100 in FIG. 1 is shown with outer alignment rods 108. The outer alignment rods 108 pass through a first set of alignment holes in the bearing supporting bracket 102 and are secured with nuts 110.

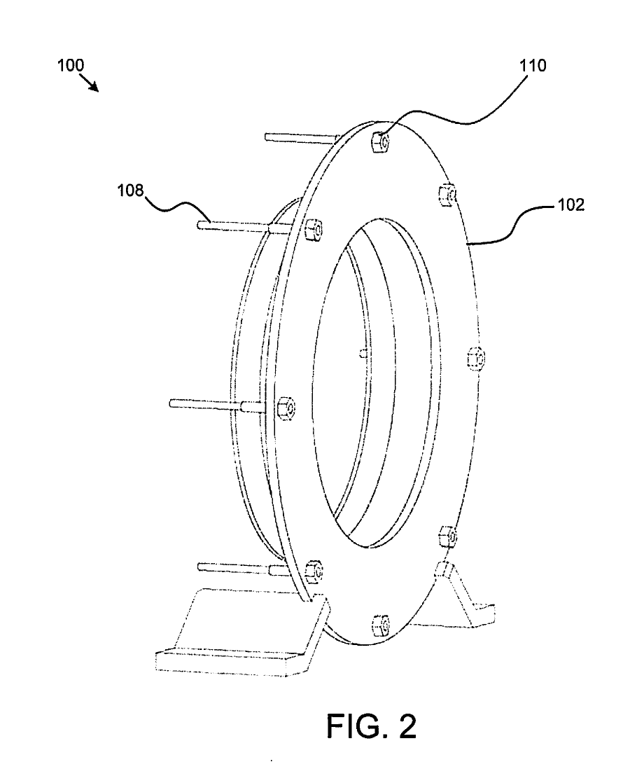

FIG. 2 shows the stationary shutter assembly 100 from a different view than seen in FIG. 1. In this view, the outer alignment rods 108 can be seen as secured to the bearing supporting bracket 102 with nuts 110.

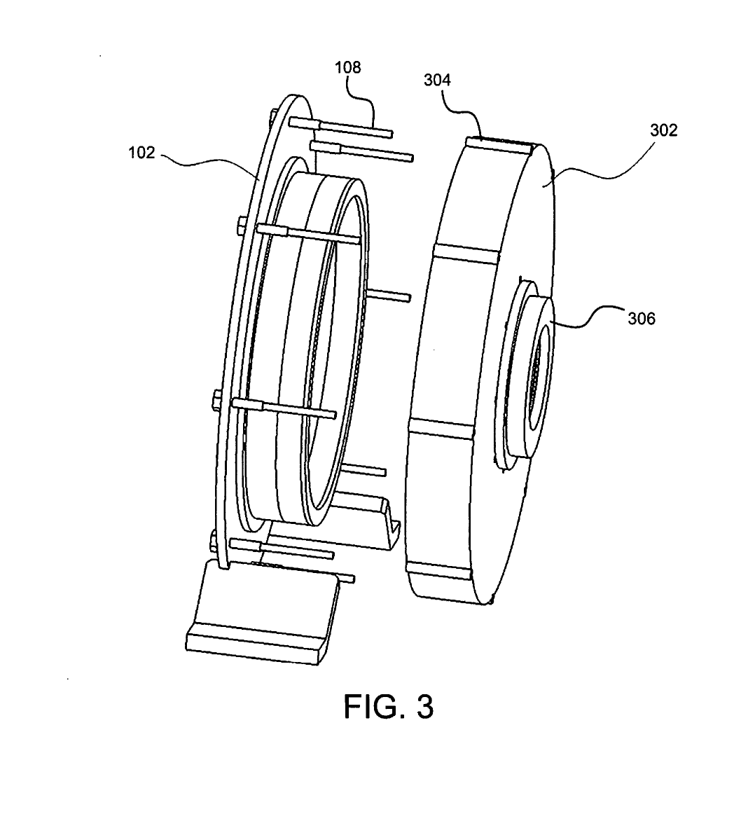

FIG. 3 shows the stationary shutter assembly as described above as well as an outer rotor assembly 302. The outer rotor assembly 302 has second set of alignment holes which are outer rotor alignment holes 304 that are on the circumference of the outer rotor assembly 302 and are configured to align with the outer alignment rods 108. In addition, the outer rotor assembly has an outer rotor interface 306 that will be described in more detail below.

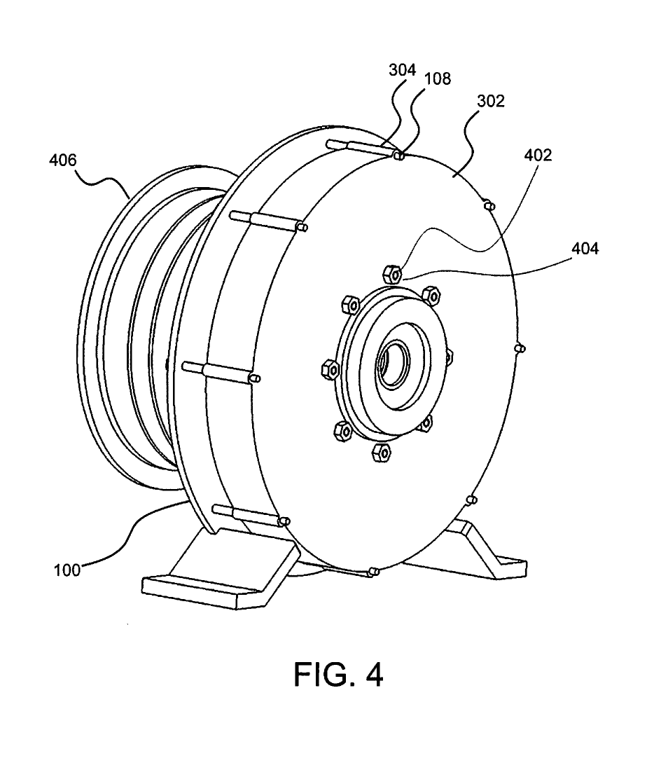

FIG. 4 shows the outer rotor assembly 302 that has been coupled to the stationary shutter assembly 100 by inserting the outer alignment rods 108 into the outer alignment holes 304. In addition, FIG. 4 shows inner alignment rods 402, which are pass through a third set of alignment holes in the outer rotor assembly 302 and are secured with nuts 404. Finally, FIG. 4 shows an inner rotor assembly module 406 that will be described in more detail below.

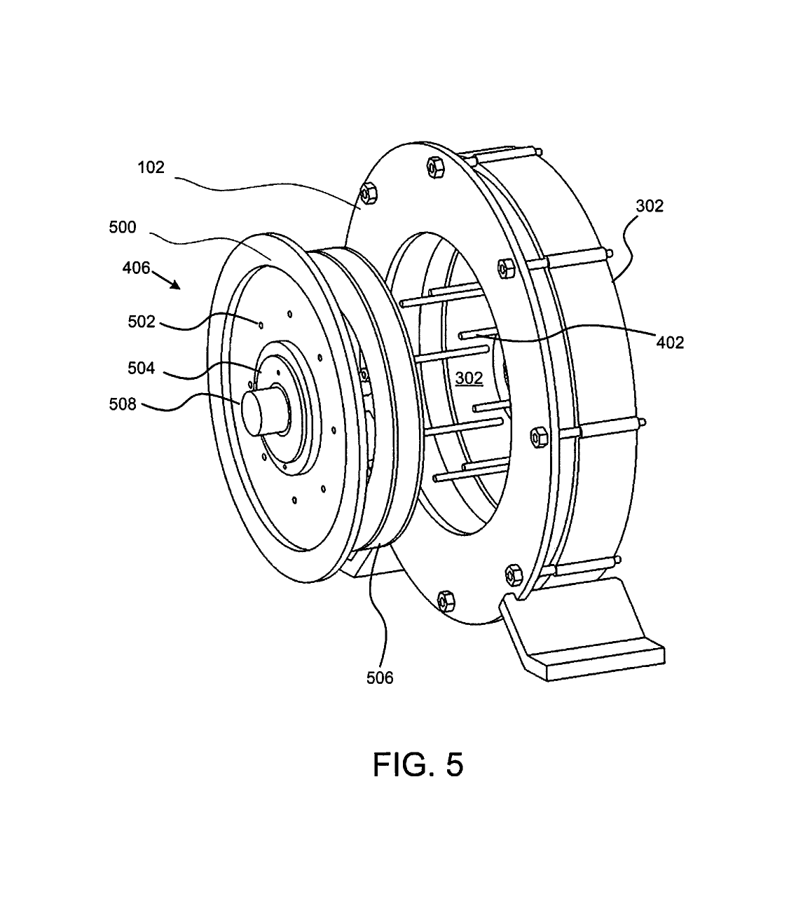

FIG. 5 shows the inner alignment rods 402 that are coupled to the outer rotor assembly 302 as described above in connection with FIG. 4. As seen in this FIG. 5 the inner rotor assembly module 406 has a fourth set of alignment holes 502 that correspond to the positions of the inner alignment rods 402. Furthermore, the inner rotor assembly module 406 has a bearing housing 500, first bearing 504, an inner shaft 508, and an inner rotor magnetic assembly 506. The inner rotor magnetic assembly contains permanent magnets. In this configuration, the inner shaft 508 and inner rotor magnetic assembly 506 can rotate relative to the bearing housing 500.

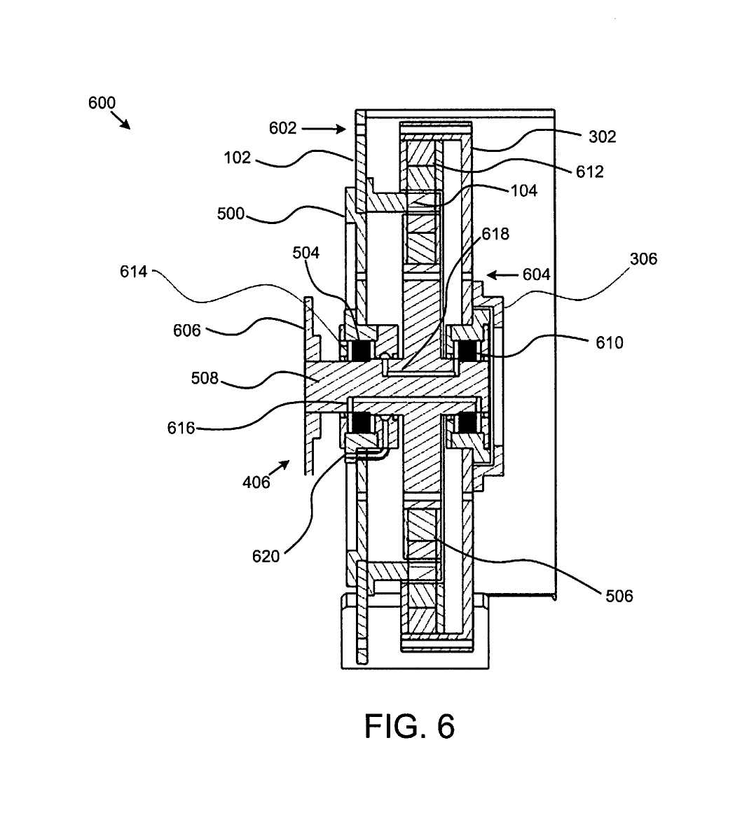

Turning to FIG. 6, the three main components described in connection with FIGS. 1-5—the bearing support bracket 102, the outer rotor assembly 302, and the inner rotor assembly module 406—are shown assembled together in a cross sectional view. The inner rotor assembly module 406 includes the inner rotor interface 606, the inner rotor 508 and the inner rotor magnetic assembly 506. The bearing supporting bracket 102 is coupled to the shutter supporting bracket 104, and the shutter supporting bracket 104 extends perpendicularly from the bearing supporting bracket 102. The outer rotor assembly 302 includes the outer rotor interface 306 and the outer rotor magnetic assembly 612. The outer rotor magnetic assembly is positioned circumferentially outside the shutter supporting bracket 104. The inner rotor magnetic assembly 506 is positioned circumferentially inside the shutter supporting bracket 104.

Continuing with FIG. 6, outer alignment holes 602 can be seen as going through the bearing supporting bracket 102 and outer rotor assembly 302. In addition, inner alignment holes 604 can be seen going through the outer rotor assembly 302 and inner rotor assembly module 406 (both the bearing housing 500 and the inner rotor magnetic assembly 506). The bearing housing 500 attaches to the bearing supporting bracket 102 and houses the first bearing 504. As can be seen in this figure, the first bearing 504 couples inner rotor 508 to the bearing supporting bracket 102 while allowing the inner rotor 508 to rotate relative to the bearing supporting bracket 102. The bearing supporting bracket 102, inner rotor assembly 406, outer rotor assembly 302, first bearing 504 and second bearing 610 form a magnetic gear 600.

The second bearing 610 couples the inner rotor 508 to the outer rotor assembly 302, while allowing the outer rotor assembly 302 to rotate relative to the inner rotor 508. As seen in this FIG. 6, the inner alignment rods 402 (FIG. 5) and outer alignment rods 108 (FIG. 1) can be removed because the first bearing 504 and second bearing 610 hold the bearing support bracket 102, inner rotor assembly 406 and outer rotor assembly 302 in place.

FIG. 6 also shows one embodiment of a lubrication system for a magnetic gear 600. In this embodiment, the first bearing 504 contains a lubrication inlet 614 that is configured to allow a lubricant to enter the first bearing 504. The lubricant may lubricate and cool the first bearing 504. Lubricant in the first bearing 504 can exit the first bearing 504 and travel to the second bearing 610 via the first conduit 616 in the inner rotor 508. In this embodiment, the first conduit 616 connects outer portion of the first bearing 504 to the outer portion of the second bearing 610. The lubricant may then lubricate and cool the second bearing 610. The lubricant can then exit the inner portion of the second bearing 610 through the second conduit 618 in the inner rotor 508. The lubricant may then exit the magnetic gear 600 through a lubricant outlet 620. In this embodiment, the lubrication inlet 614 and lubrication outlet 620 are stationary with respect to the circular bearing support bracket 102 and they are both located on the same side of the magnetic gear 600. As such, the fluid connections that provide the lubrication can be conveniently attached to stationary portions of the magnetic gear 600, which may simplify the assembly and servicing of the lubrication system. In addition, by being placed on the same side of the magnetic gear 600, the lubrication system may simplify the assembly, maintenance, and/or repair of the magnetic gear 600.

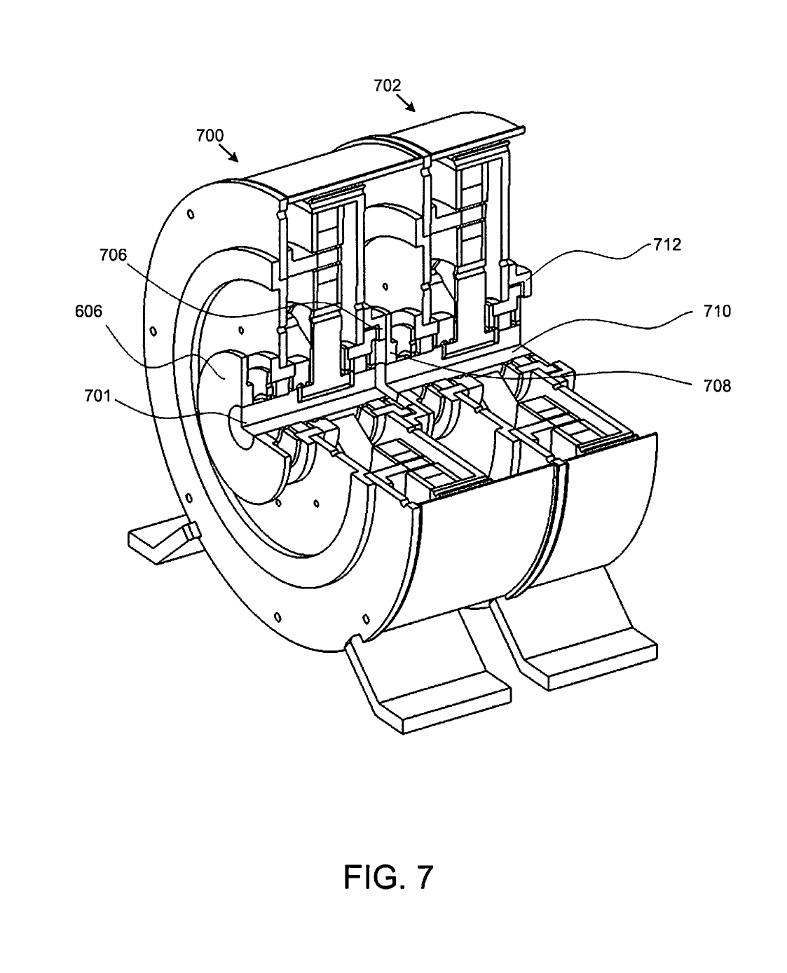

Turning to FIG. 7, a first magnetic gear 700 and second magnetic gear 702 are coupled together to make a multi-stage magnetic gear system. In this figure, the inner rotor 701 of magnetic gear 700 has an inner rotor interface 606 that may be used to connect the inner rotor 701 to another assembly, such as another magnetic gear or a generator (not shown). The first magnetic gear 700 also has an outer rotor interface 706 that couples to an inner rotor interface 708 on the inner rotor 710 of the second magnetic gear 702. Finally, the second magnetic gear 702 has an outer rotor interface 712. Therefore, when the first magnetic gear 700 is coupled to the second magnetic gear 702, the inner rotor interface 606 and outer rotor interface 712 are available as input/output interfaces. Although FIG. 7 shows two magnetic gears, additional magnetic gears could be added to increase the number of stages of the magnetic gear system to achieve a required gear ratio and torque requirement.

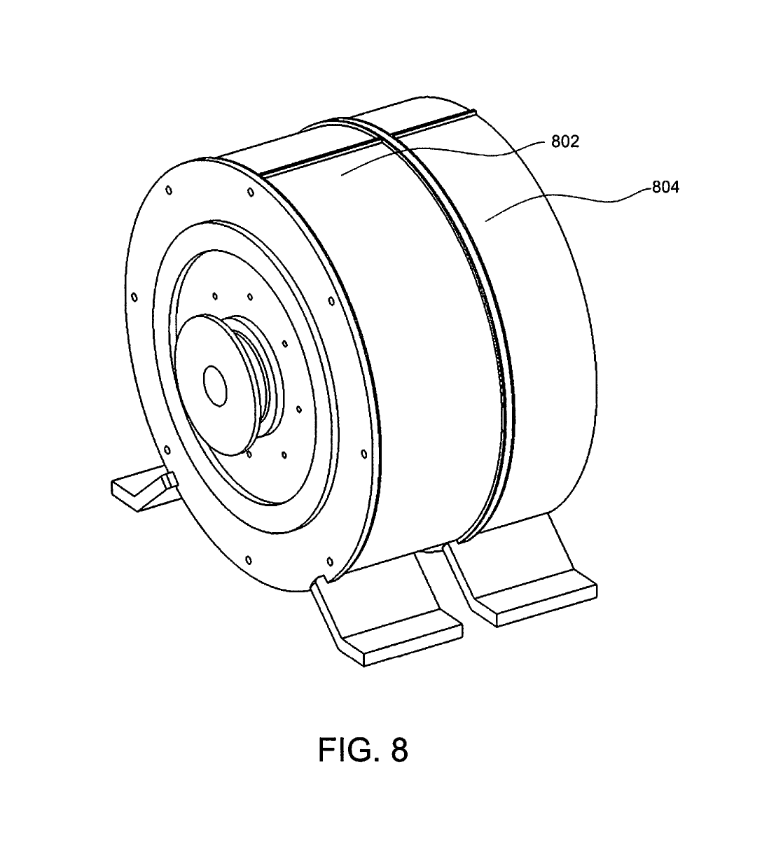

FIG. 8 shows the multi-stage magnetic gear assembly of FIG. 7 with gearbox covers 802 and 804 respectively. In this embodiment, the main function of gearbox covers 802 and 804 is to cover and protect the moving parts described in connection with FIGS. 1-7.

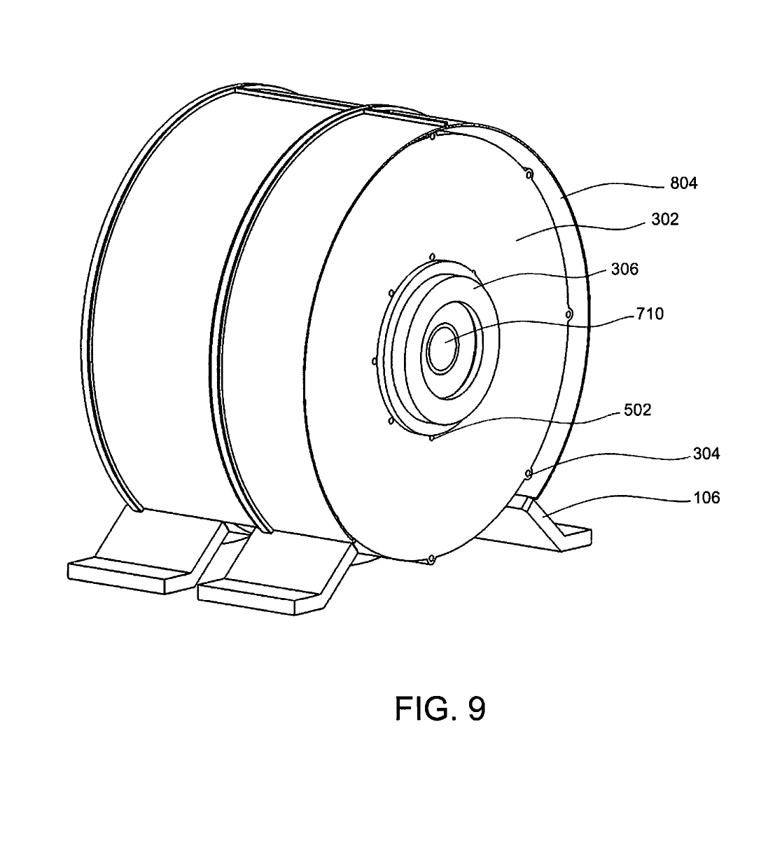

FIG. 9 shows the multi-stage magnetic gear system of FIG. 8 from a different angle. From this angle, one can see the outer rotor interface 306, inner rotor 710, inner alignment holes 502, outer alignment holes 304, feet 106, and gearbox cover 804.

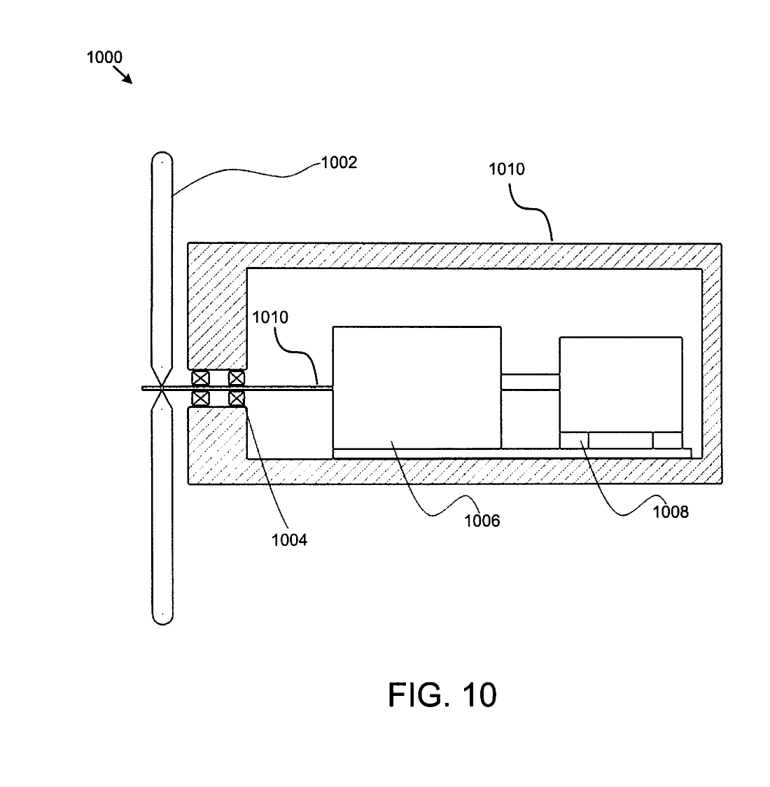

FIG. 10 shows one application of a multi-stage magnetic gearbox as described above in connection with FIGS. 1-9. FIG. 10 shows a wind turbine 1000 having blades 1002. The blades 1002 are connected to a shaft 1010 that is supported by rotor bearings 1004. The shaft 1010 is coupled to a magnetic gearbox 1006, which may include multiple stages, as was described above. The magnetic gearbox 1006 is then coupled to an electric generator 1008.

In some embodiments, the electric generator 1008 may be rated in the range of multi-Mega Watts (MW). In addition, the gear ratio of the magnetic gearbox 1006 may be in the range of about 1:100. For example, the magnetic gearbox 1006 may include two magnetic gears 600 with each having a gear ratio of 1:10. The magnetic gears 600 may be configured (including selecting appropriate magnets) to operate at a torque of about, or exceeding, 1.2 MNm. In addition, in some applications such as wind turbines, the input speed to the magnetic gear may be about 16 revolutions per minute.

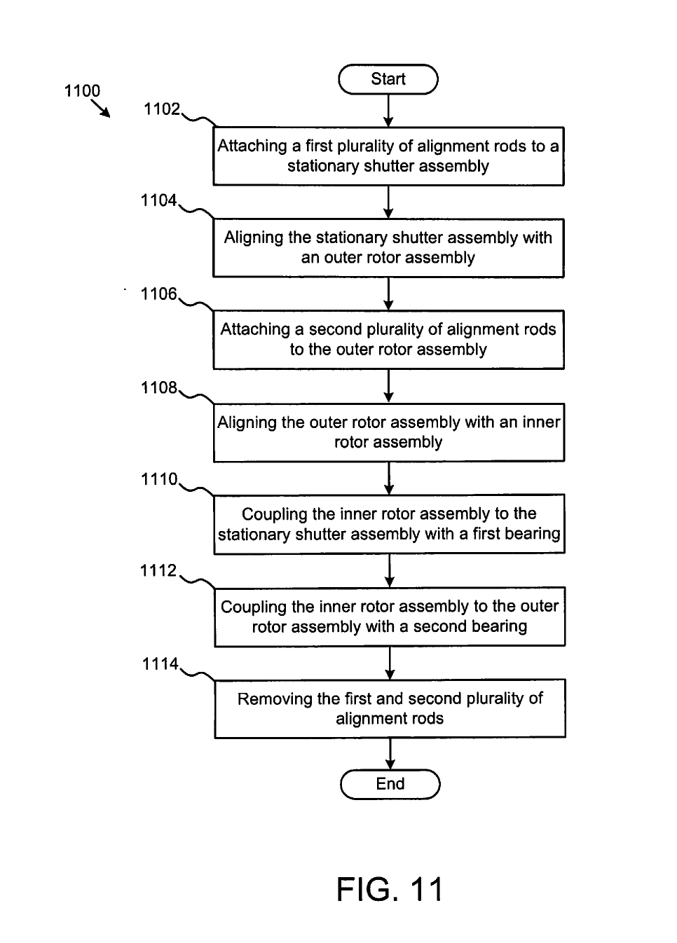

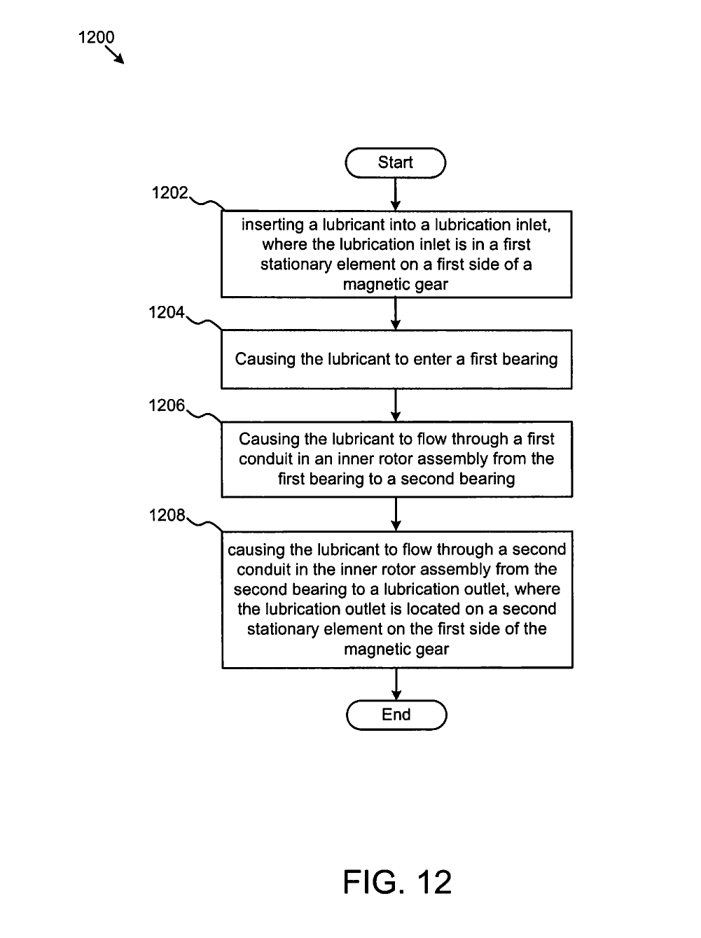

The schematic flow chart diagrams in FIGS. 11-12 are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 11 shows one embodiment of a method 1100 for assembling a magnetic gear as shown in connection with FIGS. 1-6. In this embodiment, the method begins with the step 1102 of attaching first plurality of alignment rods to a stationary shutter assembly. The result could be the assembly shown in FIG. 1, for example. The method 1100 continues to step 1104 of aligning the stationary shutter assembly with an outer rotor assembly. The result of this step could be the assembly shown in FIG. 4, for example. The method 1100 then continues to step 1106 of attaching a second plurality of alignment rods to the outer rotor assembly. The result of this step could be the assembly shown in FIG. 5, for example.

The method 1100 continues with step 1108, aligning the outer rotor assembly with an inner rotor assembly. As seen in FIG. 5, the inner rotor assembly may have alignment holes that correspond to the second plurality of alignment rods. The method continues to step 1110 of coupling the inner rotor assembly to the stationary shutter assembly with a first bearing. Step 1112 includes coupling the inner rotor assembly to the outer rotor assembly with a second bearing. Finally, method 1100 continues to step 1114 of removing the first and second plurality of alignment rods.

FIG. 12 shows one embodiment of a method 1200 for cooling and/or lubricating a magnetic gearbox. The method begins with step 1202, inserting a lubricant into a lubrication inlet, where the lubrication inlet is in a first stationary element on a first side of a magnetic gear. As seen in FIG. 6, the magnetic gearbox 600 is essentially a cylinder, where the ends of the cylinder are two different sides of the gearbox. In this embodiment, the side of the magnetic gearbox that contains the inner rotor interface 504 is the first side. The side of the magnetic gear 600 that has the outer rotor interface 306 is the second side. The method continues to step 1204, causing the lubricant to enter a first bearing. Again referring to FIG. 6, in one embodiment, the first bearing 504 is the first bearing of method 1200. The lubricant may be caused to enter the first bearing 504 by injecting the lubricant under pressure.

The method continues to step 1206, causing the lubricant to flow through a first conduit in an inner rotor assembly from the first bearing to a second bearing. Referring back to FIG. 6, the first conduit 616 is located in the inner rotor assembly 406 and connects the outer portion of the first bearing 504 to the outer portion of the second bearing 610. The method continues to step 1208, causing the lubricant to flow through a second conduit in the inner rotor assembly from the second bearing to a lubrication outlet, where the lubrication outlet is located on a second stationary element on the first side of the magnetic gear. The lubricant can then be cooled external to the magnetic gear and inserted into the lubrication inlet to further lubricate and/or cool the magnetic gear. In a configuration where multiple magnetic gears are connected in series, such as shown in FIGS. 7-9, the lubricant can flow through all of the magnetic gears before being cooled. In some embodiments, each magnetic gear can have its own lubricant cooling system.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure, and/or connections may be substituted (e.g., the inner and outer rotors may be interchanged as input or output rotors). Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-Plus- or step-plus-function limitations, unless such a limitation is explicitly recited in a given claim using the phrase(s) “means for” or “step for,” respectively.

What is claimed is:

1. A magnetic gear assembly, comprising:
a stationary shutter assembly, where the stationary shutter assembly has a bearing supporting bracket and a shutter supporting bracket extending perpendicularly from the bearing supporting bracket;
an outer rotor assembly having an outer rotor magnetic assembly positioned circumferentially outside of the shutter supporting bracket;
an inner rotor assembly having an inner rotor magnetic assembly positioned circumferentially inside of the shutter supporting bracket;
a first bearing that couples the stationary shutter assembly to the inner rotor assembly; and
a second bearing that couples the inner rotor assembly and the outer rotor assembly.

2. The magnetic gear assembly of claim 1, further comprising:
a lubrication inlet in a first stationary element on a first side of a magnetic gear, where the lubrication inlet is configured to allow a lubricant to enter a first bearing;
a first conduit configured to allow the lubricant to flow from the first bearing to the second bearing;
a second conduit configured to allow the lubricant to flow from the second bearing to a lubrication outlet, where the lubrication outlet is located on the first side of the magnetic gear.

3. The magnetic gear assembly of claim 2, further comprising flood oil in the conduits.

4. The magnetic gear assembly of claim 1, further comprising:
a first set of alignment holes in the stationary shutter assembly; and
a second set of alignment holes in the outer rotor assembly, where the first and second sets of alignment holes are configured to allow a first plurality of assembling rods to hold the stationary shutter assembly and the outer rotor assembly in alignment.

5. The magnetic gear assembly of claim 4, further comprising:
a third set of alignment holes in the outer rotor assembly; and
a fourth set of alignment holes in the inner rotor assembly, where the third and fourth sets of alignment holes are configured to allow a second plurality of assembly rods to hold the outer rotor assembly and the inner rotor assembly in alignment.

6. The magnetic gear assembly of claim 1 where the magnetic gear assembly is coupled to a second magnetic gear assembly to form a multi-stage magnetic gear system.

7. The magnetic gear assembly of claim 6, where the multi-stage magnetic gear system has a gear ratio of about 100 to 1.

8. The magnetic gear assembly of claim 6, where the multi-stage magnetic gear system is configured to operate at a torque of about 1.2 MNm at an input speed of about 16 revolutions per minute.

9. The magnetic gear assembly of claim 6, where the multi-stage magnetic gear system is configured to be coupled to a wind turbine.

10. The magnetic gear assembly of claim 9, where the multi-stage magnetic gear system is also configured to be coupled to an electric generator or motor.

11. The magnetic gear assembly of claim 10, where the electric generator or motor is rated for an output between 1 Megawatt and 6 Megawatts.

12. The magnetic gear assembly of claim 1 further comprising a cover configured to attach to the stationary shutter assembly and substantially enclose the inner rotor assembly and outer rotor assembly.

13. The magnetic gear assembly of claim 1, where the stationary shutter assembly comprises feet configured to attach the magnetic gear assembly to a surface.

14. The magnetic gear assembly of claim 1, where the outer rotor magnetic assembly and the inner magnetic assemblies each comprise permanent magnets and back irons.

15. A method for assembling a magnetic gear assembly, comprising:
attaching a first plurality of alignment rods to a stationary shutter assembly, where the stationary shutter assembly has a bearing supporting bracket and an shutter supporting bracket extending perpendicularly from the bearing supporting bracket;
aligning the stationary shutter assembly with an outer rotor assembly having an outer rotor magnetic assembly positioned circumferentially outside of the shutter supporting bracket;
attaching a second plurality of alignment rods to the outer rotor assembly;
aligning the outer rotor assembly with an inner rotor assembly having an inner rotor magnetic assembly positioned circumferentially inside of the shutter supporting bracket;
coupling the inner rotor assembly to the stationary shutter assembly with a first bearing;
coupling the inner rotor assembly to the outer rotor assembly with a second bearing; and
removing the first plurality of alignment rods and the second plurality of alignment rods.

16. The method of claim 15, where the first plurality of alignment rods are positioned circumferentially around the stationary shutter assembly.

17. The method of claim 15, where the second plurality of alignment rods are positioned circumferentially around the inner rotor assembly.

18. A method for cooling a magnetic gear assembly comprising:
inserting a lubricant into a lubrication inlet, where the lubrication inlet is in a first stationary element on a first side of a magnetic gear;
causing the lubricant to enter a first bearing;
causing the lubricant to flow through a first conduit in an inner rotor assembly from the first bearing to a second bearing;
causing the lubricant to flow through a second conduit in the inner rotor assembly from the second bearing to a lubrication outlet, where the lubrication outlet is located on a second stationary element on the first side of the magnetic gear.

19. The method of claim 18, where the first stationary element is the same element as the second stationary element.

20. The method of claim 18, further comprising altering the flow rate of the lubricant to control the temperature of the first and second bearings.
